(19) United States
(12) Patent Application Publication
(10) Pub. No.: US 2010/0063726 A1
(43) Pub. Date: Mar. 11, 2010

(54) CONTEXTUALLY ENHANCED MULTI CHANNEL LOCATION BASED TOUR GUIDANCE SYSTEM

(76) Inventors: Rob Marjenberg, New South Wales (AU); Ronny Zulaikha, New South Wales (AU)

Correspondence Address: FAY SHARPE LLP, 1228 Euclid Avenue, 5th Floor, The Halle Building, Cleveland, OH, 44115, US

(21) Appl. No.: 12/523,203

(22) PCT Filed: Jan. 17, 2008
(86) PCT No.: PCT/AU2008/000058

§ 371 Date: Jul. 15, 2009

(30) Foreign Application Priority Data
Jan. 17, 2007 (AU) 2007900211

(51) Int. Cl. G01C 21/00

(52) U.S. Cl. 701/207; 701/200

(57) ABSTRACT

A system and method for delivering contextually enhanced location based media for tour guidance. Tours are constructed upon a directional tour route, the route potentially comprising optional parts. Media is associated with tour points and is delivered based on position and order along the directional tour route. Tour points also have characteristics and priorities which also affect determination of media delivery. The system can also make use of non-spatial contextually relevant data such as tour history, temporal factors and velocity in determining media selection. The system can dynamically mix multiple channels of triggered media in real time, and can adjust properties of the playing media in response to predicted movements along the route.

### FIELD OF THE INVENTION

The present invention is broadly directed to tour guidance systems. More specifically, the present invention is directed to a system for location based narration using GPS data and incorporating spatial and non-spatial elements to create intelligent, adaptive and dynamically mixed touring-type programs.

### BACKGROUND TO THE INVENTION

Recent years have seen the advent of GPS technologies for determining the location of devices within which tour based technologies have been embedded.

These are small, inexpensive and low power devices, and have been put to many commercial uses including GPS based navigation systems, and more recently, systems that provide audio commentary triggered by GPS location.

The current breed of such systems are typically targeted at automated touring systems for providing commentary on points of interest to tourists.

These tours may be in the field of sightseeing, where the content of the tour primarily relates to the immediate visual landscape or is of local interest. These tours may also serve specific niche purposes in other industry segments. This may include car launches, driver training programs or car orientation programmes, where the tour content also pertains to relevant features of the car as it responds to the changing road characteristics.

Although existing systems may be suitable for providing limited information to tourists, a number of novel features are required to support actual tours, especially multi-day tours and tours that have a natural flow, as well as supporting a range of tour planning requirements.

Furthermore, tourists often want more than just “information” associated with their GPS location. They frequently want a personalised and contextualised story, based on a pre-planned, yet adaptive schedule and delivered in real-time.

Known prior art systems typically simply trigger audio content when the current GPS coordinates are within a certain proximity to predefined coordinates. Some such systems appear to also take direction into account so that different audio can be played depending on the direction of travel. This is important when narration includes such phrases as “on your left . . . ” or “on your right . . . ”.

While existing GPS commentary systems can respond to location, there is currently no known application that delivers personalisation. Broadly speaking, existing systems are limited or deficient in the following respects. Existing systems do not typically:
provide a GPS guided audio tour based on pre-developed content for predefined routes, by selecting, mixing and playing back pre-recorded audio at predefined positions along the route;
incorporate non-spatial elements, including factors such as date and time, and where the user has already been;
use tour route concept to support functionality, such as off tour detection, return-to-tour music recommencement, and dynamic/predictive music mixing;
use a combination of spatial and non-spatial characteristics to facilitate the intelligent choice of audio selection given varying speed parameters of the running of each tour;
dynamically mix narration and music together in real-time or apply predictive fading to seamlessly fade the music volume levels and thereby improve the listening experience;
integrate standard Travel Navigation Software to permit spoken turn by turn instructions for arbitrary use by the traveler, or to return the traveler to the tour; or
integrate adaptive tour scheduler that continually compares the current time of day against the scheduled itinerary, and makes intelligent recommendations if, for example, the tour is running late.

The present invention seeks to overcome and/or ameliorate one or more of the above limitations or deficiencies.

### SUMMARY OF INVENTION

In a first aspect, the present invention provides a tour guidance system adapted to selectively deliver pre-recorded media data to a user, the tour guidance system comprising:

position identification means for determining positional data concerning the user;

data storage means adapted to store tour route data, tour point data, and media data associated with at least one tour route and/or at least one tour point;

processing means adapted to process the tour route data and/or the tour point data and selectively determine the delivery of at least a first segment of media data relevant to the user's position, the determination based on an algorithm adapted to prioritise the delivery of one or more of a plurality of segments of media data with reference to at least a predetermined tour point priority parameter; and

media delivery means adapted to deliver one or more of the plurality of segments of media data selected by the processing means.

Each segment of media data preferably has at least one media content and is in at least one media form. The media content may be selected from narration, musical score, song, or video. In a particularly preferred embodiment, the media content is selected from narration and musical score or song. The media form may be selected from narration, audio or video. In a particularly preferred embodiment, the media form is audio.

Preferably, the tour point data includes at least one tour point type. Preferable tour point types include:

Navigation type tour points. These typically represent a particular position within a tour route and indicate that the system is to deliver media data in narration media form and having media content that provides geographical directions to a user of the system;

Narration type tour points. These typically represent a particular position within a tour route and indicate that the system is to deliver media data in narration media form and having media content of general interest or of relevance to the user's position;

Stop type tour points. These typically represent a particular position within a tour route and indicate to the system a location where a user can arrive (which is on or within the tour route) at which it is likely to remain and possibly move around (without going off route) for a period of time. Accordingly, stop type tour points typically also include a stop zone region and a minimum stop time duration. The stop zone region is a geographic region surrounding the tour point. Travel anywhere within the stop zone region will not be considered by the system to be off tour. If the user stays within the stop zone region for at least the minimum stop time duration, the system will flag that the user has stopped at the relevant stop type tour point. At a stop type tour point the typical media data that is delivered may be in narration media form and/or music media form; and

Music type tour points. These typically represent a particular position within a tour route and indicate that the system is to deliver media data in audio form and having media content of a musical score or song.

More than one of a navigation type tour point, a narration type tour point, a music type tour point and a stop type tour point may be encountered by the system substantially simultaneously or within substantially the same vicinity. The processing means applies the algorithm to selectively determine which one or more of the plurality of media segments should be delivered by the media delivery means and in what order media segments should be delivered.

According to the algorithm, the system is adapted so that it can deliver a segment of music media data simultaneously with a segment of media data associated with a navigation type tour point, a narration type tour point or a stop type tour point.

Preferably, a segment of media data having narration media form and a segment of media data having music media form are delivered simultaneously. To achieve this capability, the media delivery means of preferred embodiments has at least two media delivery channels. Each media channel is adapted to deliver media data with at least one media form (and at least one media content). In a particularly preferred embodiment, the media delivery means includes a narration delivery channel and a music delivery channel. The media delivery means may also include a video delivery channel.

Also, according the algorithm, the system is adapted so that it can deliver several segment of media data in a predetermined order.

The tour point priority parameters are used by the algorithm to make determinations regarding which segment or segments of media data are to be delivered at any one time. Preferably, the tour point priority parameters are prioritised using Boolean settings. The parameters preferably attribute a higher priority to navigation type tour points over that attributed to narration type tour points and stop type tour points, which are attributed substantially equal priority to one another.

Accordingly, if the position identification means determines that the system is adjacent to, or has passed, a navigation type tour point, the application of the algorithm results in the relevant media data for that navigation type tour point to be delivered irrespective of, and in substitution for, any other media data relevant to an adjacent narration type tour point or stop type tour point that may be being delivered by the system at that time.

In some such embodiments, once the segment of media data delivered for the relevant navigation tour point has completed being delivered, the remainder of the segment of media data associated with the narration type tour point or stop type tour point that was previously being delivered may continue to be delivered. Alternatively, depending on the position of the user, the algorithm may determine that the remainder of that segment of media data should not be delivered.

In another preferred embodiment, the algorithm prioritises the delivery of one or more of a plurality of segments of media data with further reference to at least one location specificity parameter. Preferred location specificity parameters include:

Location specific points. These typically represent a characteristic of a tour point and are an indication to the system that a particular segment of media data relevant to the current tour point is delivered at this specific position or is inhibited from being delivered;

Floating points. These typically represent a characteristic of a tour point and are an indication to the system that a particular segment of media data relevant to the current tour point is general in nature, its order in the narrative is important, and it is relevant to be delivered regardless of the user's specific location; and

Nudge points. These typically represent a characteristic of a tour point and are an indication to the system that a particular segment of media data relevant to the current tour point is relevant to a particular region starting at the location of the tour point, and finishing at a predetermined location on the tour route specified by an end nudge zone marker.

In preferred embodiments, depending on the location specificity parameter and the tour point priority parameter, when a tour point is encountered whilst a particular segment of media data is already being delivered on a particular audio channel, application of the algorithm can determine any one of a number of alternatives including:

Inhibit delivery of the segment of media data that is currently being delivered on that channel, and selectively deliver a different segment of media data;

Continue delivery of the segment of media data currently being delivered on that channel, and inhibit delivery of a different segment of media data that the system would otherwise cause to be delivered; and

Queue the delivery of a different segment of media data than is currently being delivered. When the segment of media data that is currently being delivered completes, application of the algorithm can then determine, based on the user's position, whether the queued segment of media data is delivered or not. Preferably, such queuing is applied according to first in first out principles.

In other preferred embodiments, the algorithm further utilises non-spatial data including the current date and time and data relating to where the system has already been within or outside a particular tour route or tour routes in making determinations as to which of one or more of a plurality of segments of media data to be delivered at any given time,

A tour route of preferred embodiments includes at least one path option for a user to take. Paths can join to one or more other paths, preferably in a directed manner, where a path represents an optional part of the tour. Each path consists of at least one line segment, a line segment defined by route points at either end. Where a path consists of multiple line segments, adjoining line segments share a route point.

Each route point is preferably defined by a longitude and latitude. The system preferably uses the positional data determined by the position identification means and the tour route data to identify the location of the user on a particular tour route.

In some preferred embodiments, each route point is also associated with a predetermined nominal tour point arrival time which represents the time at which a nominal user might arrive at that particular route point from when it started travelling along the corresponding path option. The nominal tour point arrival time is used, in some preferred embodiments, to calculate a nominal position within a segment of media data from which that segment of media data should be delivered. In one embodiment, the nominal tour point arrival time is used when the user is returning to a tour route after having been off route.

In yet still further preferred embodiments, the system further utilises tour state data in determining which segment of media data to deliver. Preferably, the tour state includes a list of tour points types that have been passed. This list is emptied when the tour is started, and is updated by the system as the user travels within a tour route.

Preferably, the system selectively determines which of a subset of segments of media data related to a particular tour point should be delivered based on the tour state data. In one preferred embodiment, the subset of segments of media data include

a segment containing data appropriate for when the user already passed the relevant tour point;

a segment containing data appropriate for when the user will pass that tour point some time in the future; and

a segment containing data appropriate for the season in which the tour route is being taken.

In some such preferred embodiments, the system uses conditions to determine which segment of media data to deliver. The conditions may include:

Passed Tour Point Conditions. These specify to the system to check whether the user has actually passed a specific tour point;

Stop Point Dependent Conditions. These specify to the system to check whether the user passed a particular tour point, and remained in the vicinity of that tour point for a minimum duration;

Time Dependent Conditions. These typically specify to the system to check the current time at which the user has arrived at a particular tour point;

Date Dependent Conditions. These typically specify to the system to check the current date on which the user is taking the tour route;

Attraction Opening Times Dependent Conditions. These typically specify to the system to check an attraction opening times database containing information regarding facility opening times. Conditions based on attraction opening times can also be date and/or time relative. Preferably, the attraction opening times database identifies each attraction by name, and includes a list of opening times. The opening times can be specified differently based on day of week or day of month, and can also include exception cases;

Tour Scheduler Dependent Conditions. These typically specify to the system to check tour scheduler data containing information regarding tour activities. Tour scheduler data can be used to assist the user to complete the relevant tour by a specific time. In one preferred embodiment, the tour scheduler data dependant condition is used to deliver media data advising the user not to travel to an attraction if, based on the current time and travel at average speeds, the attraction is unlikely to be open when the user would arrive at that attraction; and

Speed Dependent Conditions. These typically specify to the system to check the current travel speed;

Acceleration Dependent Conditions. These typically specify to the system to check the current speed relative to the speed at a previously nominated time.

In further preferred embodiments, the system also uses expressions to address complex circumstances. Preferably, an expression combines a condition. Expressions can include:

A Boolean condition:

The logical inverse of Expression 1;

The logical conjunction of Expression 1 with Expression 2;

The logical disjunction of Expression 1 with Expression 2; and

A named expression. Named expressions are used in a plurality of locations.

One or more of the conditions and/or expressions can be used in varying embodiments of the invention.

In a second aspect, the present invention provides a logic unit adapted for integration with the tour guidance system of the first aspect of the invention, the logic unit adapted to dynamically mix at least two segments of media data being delivered to a user of the tour guidance system, said logic unit comprising:

predicted position determining means adapted to predict the likely position, relative to the tour route, at which the user will arrive in a predetermined time interval;

tour point determining means adapted to determine whether there is one or more tour points between a previously determined predicted position and the predicted likely position; and

altering means adapted, depending on the presence of at least one tour point between the previously determined predicted position and the predicted likely position, to selectively alter a first property of a first segment of media data and/or a second property of at least a second segment of media data,
said alteration made with reference to the tour point type of the one or more tour points between the previously determined predicted position and the predicted likely position and the type of media data being delivered when the predicted likely position is determined.

In a preferred embodiment, the predicted position determining means further comprises:

direction identification means adapted to determine the direction in which the user is travelling relative to the tour route; and

speed determining means adapted to determine the approximate average speed at which the user is travelling.

The direction identification means preferably determines the direction in which the user is travelling by reference to a determined position of the user on the tour route relative to the position data provided by the position determining means.

The speed determining means preferably determines the approximate average speed at which the user is travelling by dividing the distance between at least two position data parameters provided by the position determining means by the time it took for the user to travel between those two position data parameters.

The logic unit preferably determines the predicted likely position using the direction in which and the speed at which the user is travelling by determining where, relative to the tour route, the user is likely to be in a predetermined time interval. In one preferred embodiment, the predetermined time interval is between 2 and 8 seconds, and in particularly preferred embodiments the predetermined time interval is 3 seconds. However, in alternative embodiments, the predetermined time interval may be of any duration.

In preferred embodiments, if the tour point determining means determines there is at least one tour point between the previously determined predicted position and the predicted likely position, the logic unit assesses the tour point data to determine the tour point type. The logic unit also determines whether a first segment of media data is currently being delivered by the tour guidance system.

Preferably, the first media segment is in narration or audio media form and has narration or music score or song media content. The second media segment is in narration or audio media form and has narration or music score or song media content.

In such preferred embodiments, the first and second properties altered by the altering means are the volumes of the respective segments of media data.

In an alternative embodiment, the first and/or second segment of media data is in video form. In such embodiments, the corresponding property altered by the altering means is brightness of the relevant segment of media data.

In a third aspect, the present invention provides a method of providing tour guidance to a user in accordance with position data, comprising:

storing tour point data for a plurality of tour points to be visited by a user in a tour, the tour point data including:
information regarding the location of at least one tour point;
a segment of media data relevant to at least one tour point; and
a priority parameter associated with at least one tour point;

determining position data relevant to the position of the user during a tour; and

in accordance with the position data determining that the user is adjacent a tour point, selectively delivering to the user a first segment of stored media data relevant to that tour point in accordance with the priority parameter.

Preferably, the tour point data stored in the method of the second aspect includes:
information regarding the location of each tour point;
a segment of media data relevant to each tour point; and
a priority parameter associated with each tour point.

The selective delivery of the stored media data may take place in accordance with a determination of whether a second segment of stored media data is currently being delivered to the user.

The priority parameter may be used to determine a selection from the group of:

discontinuing delivery of the second segment of stored media data to the user in preference to delivery of the first segment of stored media data;

continuing delivery of the second segment of stored media data and not delivering to the user said first segment of stored media data;

continuing delivery of the second segment of stored media data until completion, and then selectively delivering the first segment of stored media data to the user; and

queuing delivery of the second segment at least until completion of delivery of the first segment of media data, and then determining, based on the position data, whether the queued segment of media data is delivered or not.

The tour point data may include a location specificity parameter, and the selective delivery of the stored media data for that tour point may take place in accordance with a determination based on the specificity parameter. Preferred location specificity parameters include Location specific points, Floating points and Nudge points as described above with reference to the system of the first aspect of the invention.

In other preferred embodiments, the method further utilises non-spatial data including the current date and time and data relating to where the position data indicates the user has already been within or outside a particular tour route or tour routes in making determinations as to which of one or more of a plurality of segments of media data to be delivered at any given time,

The method may include the step of, in accordance with the specificity parameter, only delivering the first segment of stored media data relevant to a tour point on determination that the user is within a prescribed distance of that tour point.

The segment of media data may be an audio file selected from the group of:

a narration providing information to the user concerning a site or object at or near to the tour point or be of general relevance to the tour;

a music segment selected in accordance with the tour point; and

a navigation instruction providing directions to the user.

Preferably, the method also includes the step of referring to predetermined Boolean settings to determine the priority of media data to be delivered. Preferably, when selecting the segment of media data to be delivered, a higher priority is attributed to navigation instructions than to narration.

One preferred embodiment of the method of the third aspect includes the step of delivering navigation instructions and narration through a first media delivery channel and delivering the music segment through a second media segment. Preferably, the method also includes the step of delivering the music segment simultaneously with a narration or navigation instruction.

In a fourth aspect, the present invention provides a media mixing method for dynamically mixing at least two segments of media data being delivered according to the method of the third aspect of the invention, said media mixing method comprising:

predicting the likely position, relative to the tour, at which the user will arrive in a predetermined time interval;

determining whether there is one or more tour points between a previously determined predicted position and the predicted likely position; and

depending on the presence of at least one tour point between the previously determined predicted position and the predicted likely position, selectively altering a first property of a first segment of media data and/or a second property of at least a second segment of media data,
said alteration made with reference to the tour point data of the one or more tour points between the previously determined predicted position and the predicted likely position and a type of media data being delivered when the predicted likely position is determined.

In a preferred embodiment, the step of determining the predicted likely position includes:

determining the direction in which the user is travelling relative to the tour route; and

determining the approximate average speed at which the user is travelling.

The direction in which the user is travelling is preferably determined by reference to a determined position of the user on the tour relative to the position data.

The speed at which the user is travelling is preferably determined by dividing the distance between at least two position data parameters by the time it took for the user to travel between those two position data parameters.

The predicted likely position is preferably determined using the direction in which and the approximate average speed at which the user is travelling and determining where, relative to the tour, the user is likely to be in a predetermined time interval. In one preferred embodiment, the predetermined time interval is between 2 and 8 seconds, and in particularly preferred embodiments the predetermined time interval is 3 seconds. However, in alternative embodiments, the predetermined time interval may be of any duration.

In another preferred embodiment, the media mixing method further comprises determining whether a first segment of media data is currently being delivered by the tour guidance system.

Preferably, the first media segment is music or narration and the second media segment is music or narration. In such preferred embodiments, the first and second properties altered by the altering means are the volumes of the respective segments of media data.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention before the priority date of the patent application filed with this specification.

In order that the present invention may be more clearly understood, preferred embodiments will be described with reference to the following drawings.

### BRIEF DESCRIPTION OF THE DRAWINGS

FIG. 1 is a block diagram illustrating the hardware components of a preferred embodiment of the system of the present invention;

FIG. 2 is a block diagram illustrating an example of a tour data structure for a tour route according to a preferred embodiment of the present invention;

FIG. 3 is a simple illustration of a tour route comprising a single path, representing an example of the kind of information stored within the tour route data structure of preferred embodiments;

FIG. 4 is a further example of a tour route, having multiple paths, and therefore providing ‘path options’ for a particular tour of a preferred embodiment of the present invention;

FIG. 5 is a table listing the path connections of the example tour routing FIG. 4;

FIG. 6 is a simplified line diagram illustrating how the system of a preferred embodiment of the present invention determines how the position of a tour point is specified with reference to a line segment and route point;

FIG. 7 provides a simple line diagram of a tour route;

FIG. 8 is a flow diagram illustrating the manner in which a preferred embodiment of the system determines the current position of a tourist on a tour route and commences the process for playing relevant audio to the tourist;

FIG. 9 is a flow diagram illustrating how the system of a preferred embodiment responds to a tour point having been passed;

FIG. 10 is a flow diagram illustrating how the system of a preferred embodiment determines when the audio for a specified tour point should be played;

FIG. 11 is a flow diagram illustrating how the system of a preferred embodiment responds when a music file completes playing;

FIG. 12 is a flow diagram illustrating how the system of a preferred embodiment responds when a narration file completes playing;

FIG. 13 is a flow diagram illustrating how the system of a preferred embodiment initiates playing the audio associated with a specific tour point;

FIG. 14 is a flow diagram illustrating the manner in which the system of a preferred embodiment incorporates predictive fading for music as a traveller progresses along a specific tour route;

FIG. 15 is a flow diagram illustrating how the system of a preferred embodiment evaluates a Tour Point Conditional Expression;

FIG. 16 is a flow diagram illustrating how the system of a preferred embodiment determines the initial positions list;

FIG. 17 is a flow diagram illustrating how the system of a preferred embodiment finds forward moving positions from the initial positions list;

FIG. 18 is a flow diagram illustrating how the system of a preferred embodiment selects the initial deemed position from the initial positions list;

FIG. 19 is a flow diagram illustrating how the system of a preferred embodiment determines the deemed position along the route given coordinates;

FIG. 20 is a flow diagram illustrating how the system of a preferred embodiment plays music as the traveller enters the tour route

### DETAILED DESCRIPTION OF PREFERRED EMBODIMENTS

Preferred embodiments of the system of the present invention provide a pre-defined guided tour to a user of the system by running a computer software program that selects, mixes and plays back pre-recorded audio. This tour responds dynamically to the user's state, which in turn depends on its GPS location and direction, as well as other factors, such as, where the user has been and the time and date of the tour. Preferred embodiments of the invention therefore incorporate non-spatial elements to deliver an intelligent and adaptive experience, that is dynamically mixed.

In preparing the data for presentation during a tour, ‘content developers’ initially record GPS information and audio data during the course of tour development. Interviews may be performed live in the field, with positional information retained. In this manner, knowledge of where any portion of the particular audio data was recorded is available for later access by the ‘content developer’. The ‘content developer’ may then create a tour ‘project file’, for example, in the format of ‘.hhp’, ‘.xml’ or any other preferable format. The project file specifies such items as the route that the tour should take and where the various portions of audio should be played.

The system of the present invention uses spatial and non-spatial data to appropriately deliver the project file for that route to the end user.

The system can execute on a number of different hardware platforms that meet the minimum requirements for processor speed, memory availability and audio output, as well as a GPS receiver. Suitable hardware includes, for example, a PDA with an inbuilt GPS receiver, a PDA with access to an external GPS receiver, or an infotainment/GPS navigation system currently found in higher end automobiles.

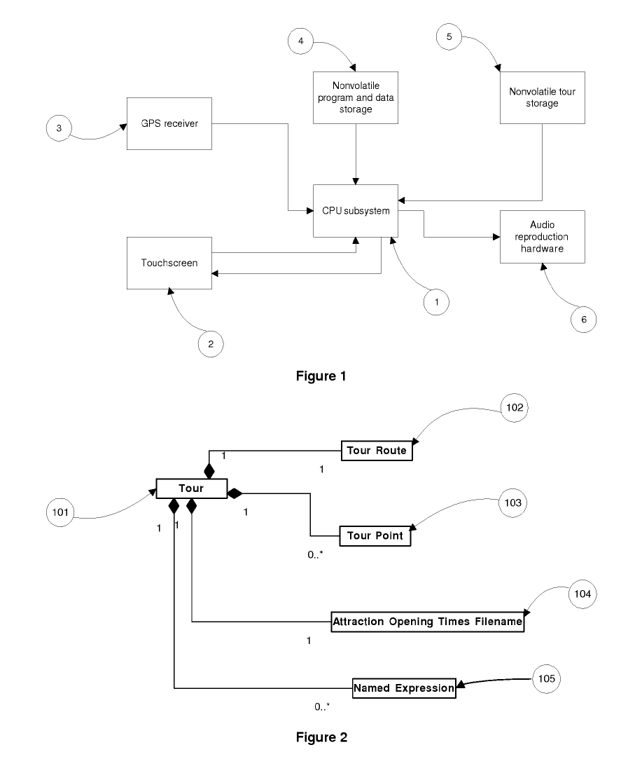

FIG. 1 shows a block diagram of the hardware components of the system. The CPU subsystem 1, include RAM/ROM, timers and a real-time clock, and runs a suitable off-the-shelf operating system, such as Windows Mobile, and a software program adapted to execute the system of the present invention.

The system includes hardware 2 for visually displaying information to the user, as well as receiving various selections from the user. A touchscreen provides a very simple and easy to use way for user interaction.

The GPS receiver 3 is a readily available off-the-shelf component for receiving radio signals from GPS satellites and processing them in such a way as to provide a regular indication of the current location in terms of longitude and latitude on the earth.

The system includes non-volatile storage 4 for storing the software program adapted to execute the system of the present invention, as well as state information as the tour progresses. Although some program state may be held in RAM, state changes of significant events are stored in non-volatile memory, so that it will be available if, for example, the system is rebooted.

The tour content is preferably stored on non-volatile media 5, such as an SD Card, CD or DVD-ROM, or on a hard disk, for example.

The audio reproduction hardware 6 takes the digital information from the CPU and converts this into an analogue audio signal suitable for connection to, for example, audio headphones, a miniature FM transmitter, or other such device.

### Tour Route Concept

The system of preferred embodiments includes the concept of a “tour route” as an integral part of the data structures within the tour project file.
Among other things, the tour route concept preferably enables the following:
Detection of when the user has come off the tour. This allows the application to give the user audio feedback, and options for returning to the tour.
Support for tours that go in both directions along a road or involve multiple passes along the same stretch of road. Supporting multiple passes is useful for tours through the centre of a town where the tour might branch out into different directions.
Support for dynamic/predictive music mixing as described below.
Support for return to tour music recommencement, as described below.

Some of these features, rely not only on a tour route, but also a nominal speed associated with each portion of the route.

### Data Structures

The invention makes use of a number of different data structures. Some of these data structures pertain to a tour project file, that specifies all aspects of a tour. Some data structures are used for internal processing whilst a tour is in progress.

### Tour Data Structure

A tour data structure 101 is a data structure that contains information regarding the entire tour. This is shown in FIG. 2, and comprises:
1. A data structure that contains the entire tour route 102.
2. A data structure consisting of multiple tour points 103.
3. Reference to a file containing the Attractions Opening Times information 104. This file consists of a database of zero or more Attraction Opening Entries.

This is loaded from non-volatile memory into RAM when a particular tour is selected by the user.
4. Zero or more named expressions, also referred to as the named expression list 105.

### Tour Route Data Structure

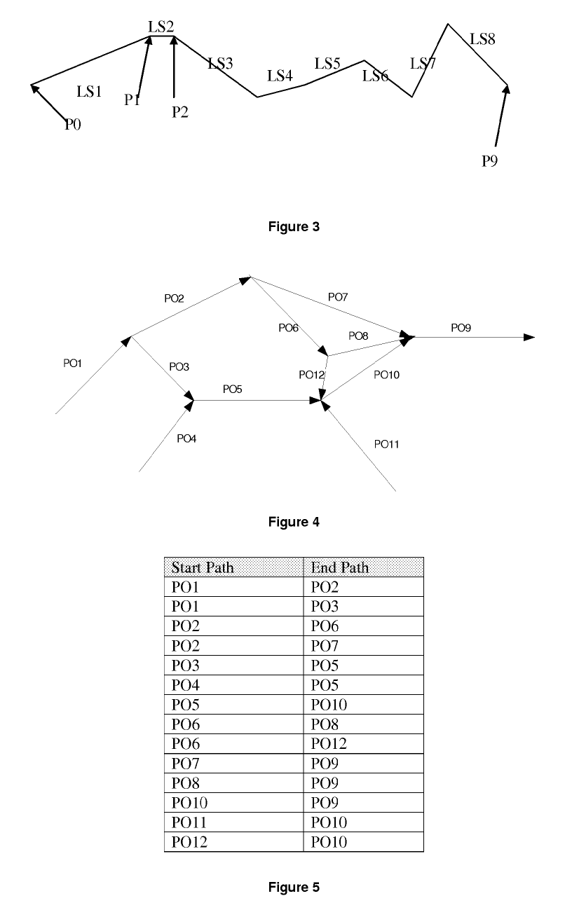

The tour route can be as simple as a single path, which could also be termed a polyline. This is illustrated in FIG. 3.

Where P0, P1 and P2 are the first three points along the path, where each point is defined by a longitude and latitude. The line segments are defined by a straight line between two adjacent points. The tour route, that is the nominal path a traveller would take consists of this path in the simple case.

To facilitate optional parts of a tour, a tour route can consist of multiple paths, whereby one path can join to one or more other paths, preferably in a directed manner, where a path represents an optional part of the tour.

In FIG. 4, PO1 through PO12 are different path options. (For simplicity in the diagram, some of these path options are shown as a single line. Each, in fact, is a path, and therefore can consist of multiple line segments.)

In a preferred embodiment, paths are identified numerically, and a table structure lists the path connections. FIG. 5 shows the path connections for the tour route in FIG. 4.

As mentioned above, each route point is defined by a longitude and latitude. In addition, each point also includes a nominal time. This time attribute specifies a nominal time (in seconds) at which a traveller could reach this point from the start of the path. This time parameter is used in calculating a nominal position within a music track when, for example, playing “return to tour” music.

Additionally, each route point preferably contains a width parameter defining the road width along the line segment to the next route point. This is used when determining whether or not particular coordinates are “on route” or “off route”.

### Tour Point Types

A tour point is specified by a position along the tour route, and has associated with it the name of the audio file that should be played when the tour point is passed.

There are a number of different tour point types. These include:
Music
Narration
Navigation
Stop

The system supports multiple audio channels, and particularly preferred embodiments support at least two audio channels—one for music, and the other for “talking”. “Talking” is defined as the audio associated with a tour point of type Narration, Navigation or Stop. Some preferred characteristics of the different tour point types are provided in the following table:

| Type | Description |
|---|---|
| Narration | Information that is either general in nature or of relevance |
| | to the user's position. |
| Navigation | Directions about an impending turn. Navigation type tour |
| | points have priority over narration and stop type tour |
| | points. |
| | As this provides important information, the system will |
| | precede playing the specific audio with a particular audio |
| | cue, for example, a chime that will grab the listener's |
| | attention. |
| | As mentioned, a navigation tour point has higher priority |
| | over anything else playing on the talking channel at that |
| | time. This means that if, for example, narration is playing |
| | when a navigation tour point is encountered, the narration |
| | is halted, and the navigation played. |
| | After the navigation has completed playing, the narration |
| | will recommence playing at the point it was interrupted. |
| | With a short interval before playing the narration, and |
| | appropriate fading down when it is being interrupted. |
| | A short story of a few minutes, for example, could be |
| | punctuated with some short navigation at appropriate |
| | points. |
| Stop | A stop point is a tour point at an attraction of some sort. |
| | Stop points preferably have the following: |
| | A geographic region around the stop point that would |
| | specify a stop zone region. This inhibits the system |
| | from concluding that the user has travelled off tour, |
| | when, for example, he or she is actually looking for |
| | parking nearby. |
| | Associated audio that would play when the user has |
| | finished visiting the attraction. This audio could be |
| | played on user demand by pressing a button on the |
| | screen. This may also give the user directions on |
| | how to get back onto the tour. |
| Music | The audio associated with this type of tour point is |
| | music, and plays on the music channel. Music tour |
| | points can also include features, such as: |
| | A parameter that specifies if the music should keep |
| | repeating along the tour route until the next music |
| | tour point is encountered. |
| | The ability to associate multiple audio files against |
| | the tour point and have these files play in sequence. |

The invention can play music and talking simultaneously, and this is described in detail below. Preferably, the audio of a single Narration, Navigation or Stop type tour point plays at any one time.

### Tour Point Priority and Location Specificity

This component of the system is adapted to deal with the possibility that different users are likely to travel the route at different speeds. This means that if there are 2 narration type tour points near each other on the route, a traveller travelling at a faster speed will hear less silence after the first narration completes prior to the second narration starting.

Preferably, at maximum reasonable speed, the first audio does not run into the second. However, this may not be possible in all cases, and a number of features have been developed to assist the content developer in selecting priorities.

Each tour point has an associated priority and a location specificity parameter as follows:
Tour point priority. This is not a numeric priority scale, or a simple low-medium-high, but rather a Boolean setting of whether this tour point has a higher priority than the previous one.
Location specificity setting

The location specificity setting indicates over what area of the route the tour point audio is valid. This is preferably one of the following:

| Type | Description |
|---|---|
| Location | The tour point audio must be played at the specified location, |
| Specific | or not at all. |
| Floating | The tour point audio is general in nature, its order in the |
| | narrative is important, and is relevant regardless of the |
| | specific location. |
| Nudge | The tour point audio is relevant to a particular area starting at |
| | the location of the tour point, and finishing at a predetermined |
| | location on the route specified by an “end nudge zone” |
| | marker. |

Depending on the location specificity setting and the tour point priority, when a tour point is encountered whilst a particular audio file is already playing on the same audio channel, the system can choose to do the following:
Stop what is currently playing on that channel, and play the new audio.
Continue what is currently playing on that channel, and refrain from playing the new audio.
Queue the new audio. When the currently playing audio completes, a decision will then be made about whether the queued audio will be played or not.

### Tour Point Data Structure

A tour point data structure consists of information pertaining to a single tour point. This includes:
Position along the tour route. The Position data structure is defined below.
Tour point type (music/narration/navigation/stop)
Tour point priority (Boolean)
Location specificity (specific/float/nudge)
Nudge type tour points also indicate the furthest position along the route at which the tour point is still relevant
Stop type tour points also include a stop zone region as well as a minimum stop time duration. The stop zone is a geographic region surrounding the tour point. This specifies a region whereby travel anywhere within this region will not be considered off tour. If the traveller stops for at least the stop point duration, within the stop zone, the system will flag that the traveller has stopped at the tour point.
Maintain narration order flag (Boolean)
A set of zero or more audio filenames, and for each a Tour Point Conditional Expression specifying the condition under which it should play.

### Tour Point Conditional Expression

A tour point conditional expression consists of:
Expression type, which can be one of {always, inverse, conjunction, disjunction, named expression, has passed, has stopped, time dependent, date dependent, attraction dependent, speed dependent, acceleration dependent}
An optional Parameter1
An optional Parameter2

The following describes the optional portions of the data structure depending on the Expression type.

| Expression type | Usage of optional parameters |
|---|---|
| Always | None |
| Inverse | Parameter1 - is a tour point conditional expression |
| Conjunction | Parameter1 - is a tour point conditional expression |
| | Parameter2 - is a tour point conditional expression |
| Disjunction | Parameter1 - is a tour point conditional expression |
| | Parameter2 - is a tour point conditional expression |
| Named | Parameter1 - name of an expression from the named |
| expression | expression list |
| Has passed | Parameter1 - name of a tour point |
| Has stopped | Parameter1 - name of a tour point |
| Time | Parameter1 - one of {Before, After} |
| dependent | Parameter2 - time of day |
| Date | Parameter1 - one of {Before, After, Equal} |
| dependent | Parameter2 - day of year |
| Attraction | Parameter1 - Attraction name |
| dependent | Parameter2 - one of {Opening, Closing} |
| | Parameter3 - timeframe in minutes |
| Speed | Parameter1 - one of {Below, Above} |
| dependent | Parameter2 - speed (kilometres per hour) |
| Acceleration | Parameter1 - one of {Below, Above} |
| dependent | Parameter2 - acceleration (kilometres per |
| | hour per second) |
| | Parameter3 - time interval to earlier speed |
| | reading (in seconds) |

### Named Expression

The purpose of named expressions is to allow for a complex expression to be defined once and used in multiple Tour Point Conditional Expressions.

The Tour Data Structure contains the Named Expression List. This consists of zero or more named expressions. Each named expression consists of:
A textual name
An expression of type Tour Point Conditional Expression

### Attraction Opening Entry

An Attraction Opening Entry defines the opening times of an attraction. It consists of the following elements:
Attraction Name
One or more attraction opening slots of type Attraction Opening Slot
Zero or more attraction opening exclusions lots of type Attraction Opening Slot. This defines any exclusions to the opening times specified by the attraction opening slots item.

### Attraction Opening Slot

This defines a time of day and day of year, and consists of the following elements:
Start time—when the attraction is open
End time—when the attraction closes
Type—One of {Weekly, Monthly, Yearly}
DaySet—a set of {Monday, Tuesday, Wednesday, Thursday, Friday, Saturday, Sunday}
MonthSpecificationType—one of {DayOfMonth, DayOfWeek}
DayOfMonth—0 . . . 31
WeekOfMonthType—one of {First, Second, Third, Fourth, Last}
MonthSet—a set of {January, February, March, April, May, June, July, August, September, October, November, December}
YearSpecificationType—one of {DayOfMonth, DayOfYear}

The following describes the optional portions of the data structure depending on the Type element.

| Type | Usage of optional parameters |
|---|---|
| Weekly | DaySet - defines the set of days pertaining to this slot |
| Monthly | MonthSpecificationType - defines a subtype |
| | If MonthSpecificationType is DayOfMonth: |
| | DayOfMonth specifies the day of month |
| | If MonthSpecificationType is DayOfWeek: |
| | WeekOfMonthType specifies the week of month |
| | DaySet - defines the set of days pertaining to this slot |
| Yearly | YearSpecificationType - defines a subtype |
| | If YearSpecificationType is DayOfMonth: |
| | DayOfMonth specifies the day of month |
| | MonthSet specifies the month or months of the year |
| | If YearSpecificationType is DayOfYear: |
| | WeekOfMonthType specifies the week of month |
| | DaySet - defines the set of days pertaining to this slot |
| | MonthSet specifies the month or months of the year |

### Position

The Position data structure specifies a point on the tour route, not directly through the use of coordinates, but rather through reference to a line segment along the route.

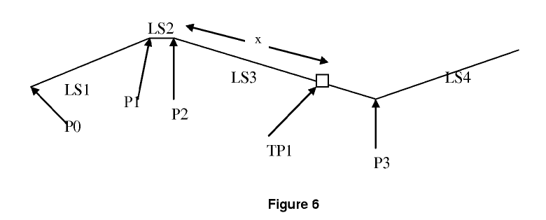

It is specified by reference to the line segment, as well as a distance from the first point of the line segment. This is shown in FIG. 6, whereby the tour point TP1 is positioned along line segment LS3, at a distance of x metres from point P2.

This data structure is used to define the location of tour points along the route, as well as for other internal processing.

### Tour Route Algorithms

The invention contains a number of algorithms for determining the current position along the route given current GPS coordinates. This algorithm is used each time the GPS receiver provides a location fix.

Given the current position along the route as well as the position along the route at the time of the last location fix, the system is able to determine what tour points, if any, have been passed. A determination that a tour point has been passed is used to trigger the audio associated with the tour point.

The algorithms also determine if the current location is too far away from the closest point on the route, in which case it deems that the traveller is off route. The algorithms and the manner in which the system applies them during a tour is discussed in more detail below.

### Processes and System Routines

A. Process GPS

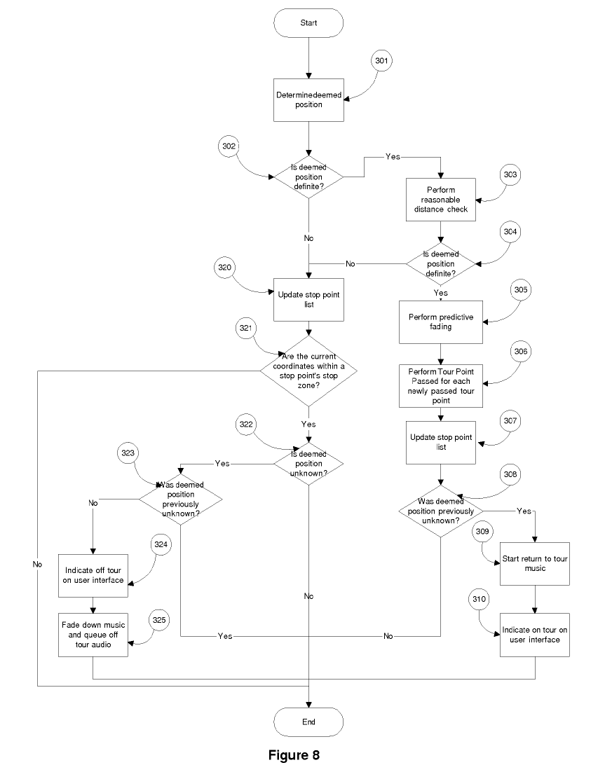

Each time GPS coordinates are available from the GPS receiver, the process illustrated in FIG. 8 is activated. This determines where on the tour route the current location represents, or if the coordinates represent a location that is off tour. Appropriate action is taken based on this result.

Step 301 calls the routine to determine the current “deemed position”. This could result in a determination that the coordinates are definitely on the route, with a route position defined by the closest line segment of the route, together with the distance along the line segment representing the point closest to the GPS coordinates.

The determination may be that the coordinates are too far away from the closest point on the route, in which case the deemed position is “unknown”. At the point where path options diverge, for example, near the intersection of PO1, PO2 and PO3 in FIG. 4, a single determination cannot be made. Given the GPS signal accuracy, coordinates near this intersection could perhaps lie on either PO2 or PO3. In such a case the deemed position is termed possible. This means that the coordinates do lie on the route, but a single definite position cannot be determined.

The deemed position will only be classified as “definite” if the position is forward along the route compared with the last determination. If the position is backward compared with the last determination, the distance between the current determination and the previous is calculated. If this distance is below a certain threshold, for example 30 m, the deemed position is classified as “minor reverse”. This allows for the traveller to perform a short reverse without the system indicating that the traveller is off route. This also allows for fluctuations in coordinates reported by the GPS receiver if the traveller is stationary to not cause an “off route” indication.

If the calculation between the current position on the route, and the previous one is such that it is greater than the threshold value for a minor reverse, the deemed position is classified as “unknown”, and the system gives an “off route” indication.

Different actions are required depending on the result of the deemed position determination. This is checked in step 302.

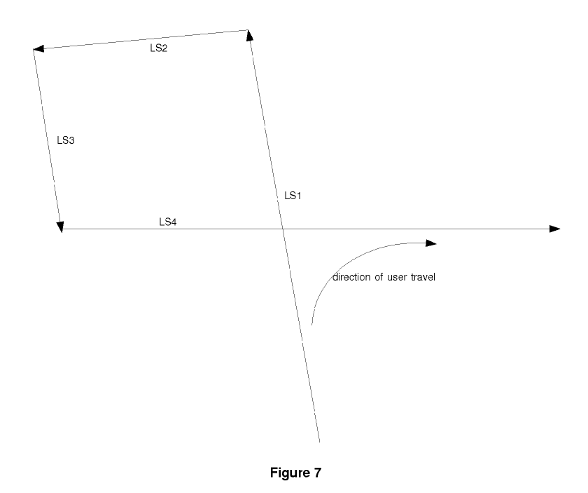

Step 303 performs a check to guard against a particular scenario. The scenario can be illustrated with reference to FIG. 7. Here, the intention is that the traveller will move along LS1, LS2, LS3 and LS4 in that sequence. However, if the traveller turns right from LS1 into LS4, step 301 will still give a definite determination of the current coordinates when the traveller is on LS4. The desired result in this case is to consider that even though the traveller is on route, he is off the tour. This step performs a distance calculation along the length of the route between the last deemed position, and the current deemed position. If this distance is above a reasonable threshold, such as 80 m, this step concludes that the traveller has come off tour, and deems the current position as “unknown”.

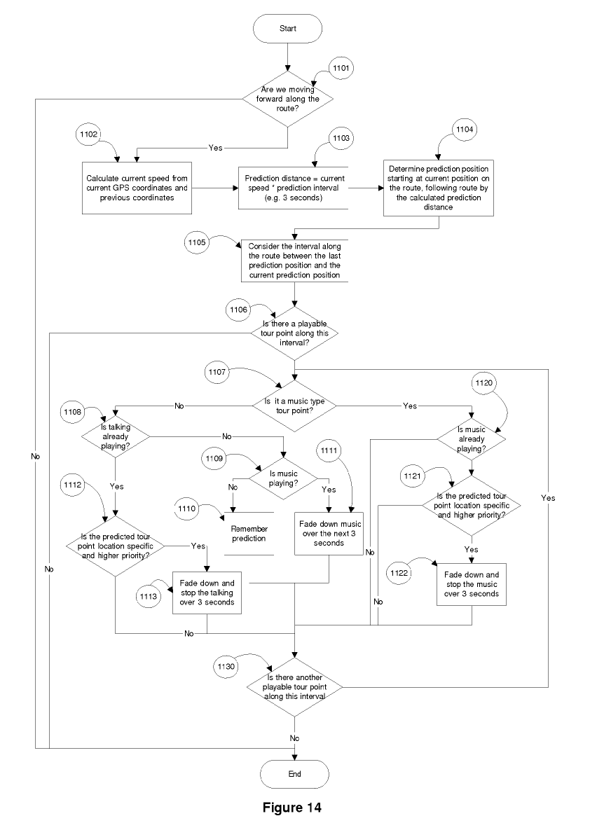

Step 305 is reached if the traveller is on tour, and calls the Predictive Fading routine shown in FIG. 14 to fade down audio as necessary.

Step 306 considers the section of the route between the current deemed position and the deemed position from the previous GPS coordinates. For every tour point located within that interval, the Tour Point Passed routine is called (see below).

Step 307 checks to see if the current coordinates are within the stop zone of any of the tour's stop type tour points. If so, this step checks to see if the GPS coordinates indicate that the traveller has been stopped for at least the stop point's minimum stop duration. If this is the case, this tour point is added to the list of stop type tour points at which the traveller has stopped.

Step 308 checks to see if the traveller has just now returned to the tour. This is the case if the previous deemed position was unknown.

Step 309 starts playing music appropriate for this return to tour condition by calling the Start Return to Tour Music routine.

Step 310 gives a visual indication of the on tour condition.

Step 320 checks to see if the current coordinates are within the stop zone of any of the tour's stop type tour points. If so, this step checks to see if the GPS coordinates indicate that the traveller has been stopped for at least the stop point's minimum stop duration. If this is the case, this tour point is added to the list of stop type tour points at which the traveller has stopped. Step 321 checks to see if the current coordinates are within the stop zone of any of the tour's stop type tour points. If so, the traveller is considered to be “on tour” regardless of whether or not he is precisely on the tour's route.

A number of steps starting at step 322 are involved in detecting and processing the off tour condition. Step 322 checks to see if the current deemed position is classified as “unknown”. Step 323 checks to see if the previous deemed position was not unknown. If both these tests succeed, the system concludes that the traveller has come off tour. This is then processed in steps 324 and 325.

Step 324 gives a visual indication of the off tour condition. Step 325 instructs the music audio processor to fade down any currently playing music, and then queues the playing of an off tour message to the talk audio processor.

B. Tour Point Passed Routine

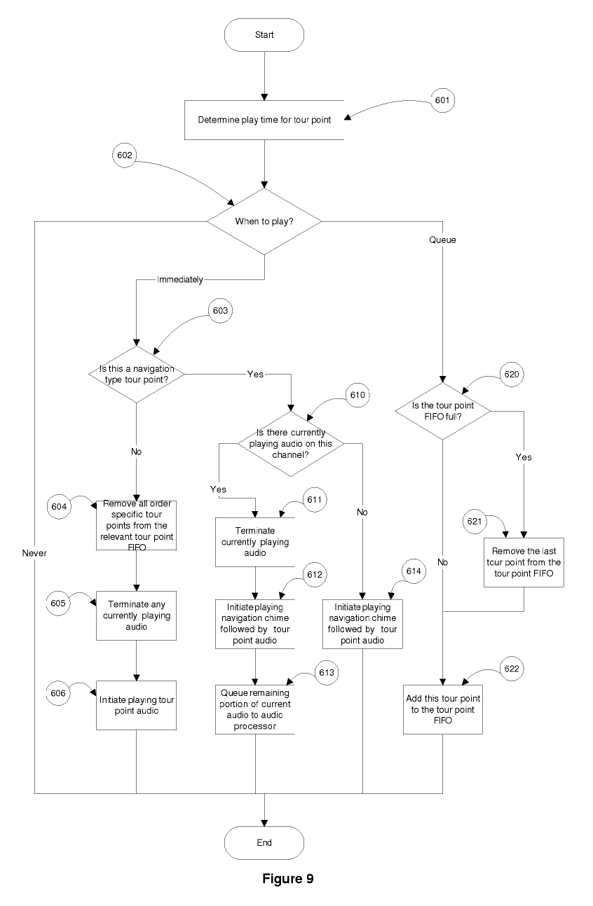

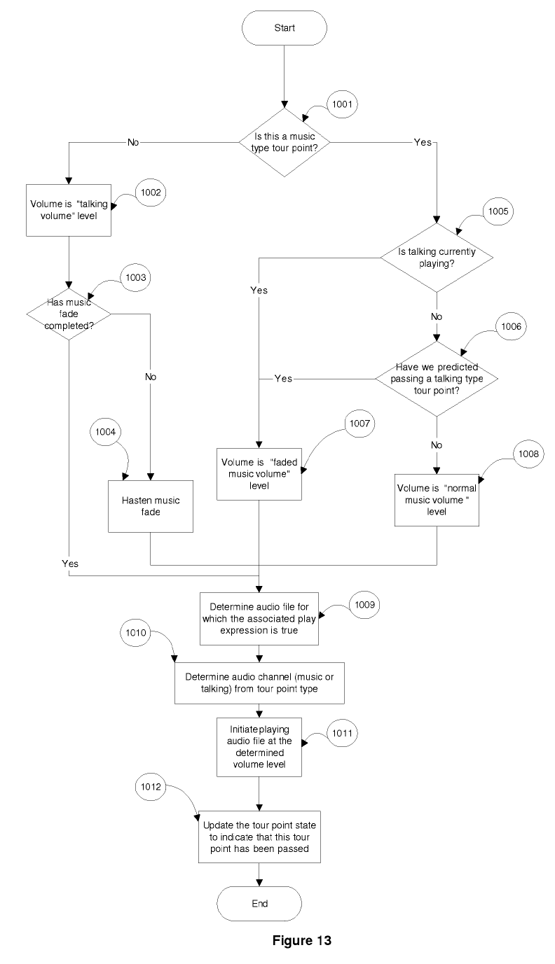

This routine is called when a tour point has been passed, and is illustrated in FIG. 9. At 601 it calls a routine to determine when the tour point's audio should be played (“Determine Play Time”). Based on the result at 602, this routine branches to take the appropriate action:
1. Does not play any audio associated with the tour point
2. Initiates playing the tour point's associated audio. Special consideration is necessary for navigation type tour points, and this test is made at 603.
   Steps 604, 605 and 606 are taken for narration and stop type tour points.
   Step 604 removes all tour points from the relevant (music/talking) tour point FIFO (“first in first out” queue) that are marked as being order specific. This is necessary as the tour points listed in that FIFO were passed prior to the tour point currently being processed and will potentially be played after this one completes. For tour points that are order specific, that later playing should not occur.
   Step 605 instructs the audio processor talking instance to terminate playing any currently playing audio.
   Step 606 calls the Initiate Audio routine to initiate playing of the appropriate audio file (see FIG. 13).
   A number of steps, starting at 610 are taken for navigation type tour points. Navigation type tour points will interrupt playing any currently playing audio, and this step determines if audio is currently playing on the talking channel.
   Step 611 instructs the audio processor talking instance to terminate playing the currently playing audio.
   Step 612 initiates the playing of a special audio file for the “navigation chime” sound on the talking audio process. This then calls the Initiate Audio routine to queue the playing of the appropriate audio file specified by the tour point with the navigation direction. The resulting sound is the navigation chime immediately followed by the navigation direction.
   This navigation audio is interrupting the currently playing narration audio. Step 613 cues a brief period of silence followed by the remaining portion of audio that was interrupted at step 611.

Step 614 is executed if there is no audio currently playing on the audio processor talking instance. It initiates the playing of a special audio file for the “navigation chime” sound on the talk audio processor. This then calls the Initiate Audio routine to queue the playing of the appropriate audio file specified by the tour point with the navigation direction. The resulting sound is the navigation chime immediately followed by the navigation direction.
3. Step 620 is the first in a number of steps taken if the tour point should not be played immediately, and should be considered for possible later playing.
   This step checks to see if the talking tour point FIFO is full, i.e. it already has a number of tour points already in queue equal to the FIFO's maximum capacity.
   Step 621 is called if the FIFO is already full, and removes the last tour point from it. This action is taken because the Determine Play Time routine (see below) has already determined that the current tour point has higher priority than the last tour point in the FIFO.
   Step 622 queues the tour point to the talking tour point FIFO, for possible later playing. Being in this queue does not guarantee that this tour point's audio will later be played, however it will be considered for playing when previous audio has completed playing.

C. Determine Play Time Routine

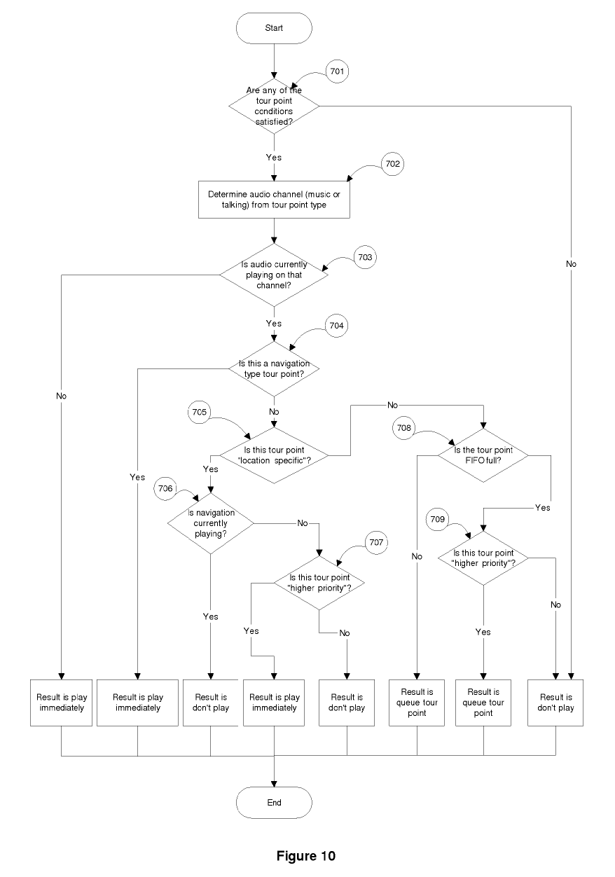

This routine determines when the audio for a specified tour point should be played, and is illustrated in FIG. 10.

The main factors involved in making this determination are:
1. If audio is currently playing on the appropriate channel, and if so is it navigation type audio (which has an implicit high priority)
2. The tour point's location specificity
3. The tour point's priority

Step 701 checks to see whether or not the conditions of play for any of the audio files associated with the tour point are satisfied. If none of the possibly multiple audio files associated with the tour point have satisfied conditions, the tour point is essentially ignored, and the routine's result is “Don't Play”.

Step 702 determines which is the relevant audio processor instance for this tour point. For music type tour points, the music audio processor instance is relevant. For narration, navigation and stop type tour points, the talk audio processor instance is relevant.

If no audio is currently playing on the relevant audio processor, then the current tour point's audio can immediately play. This is checked in step 703.

Navigation type tour points implicitly have higher priority than any audio currently playing. This is checked in step 704.

The next step in determining the play time depends on whether or not the tour point is classified as being location specific. This is checked in step 705.

Steps 706 and possibly 707 execute if the current tour point is location specific. Location specific tour points must either play immediately as they are passed, or not played at all.

As navigation has higher priority than other tour point types, whether or not the currently playing audio is for navigation is examined at step 706. If navigation is currently playing, then the current tour point has lower priority and the routine's result is “Don't Play”.

Step 707 is reached if both the current tour point and the currently playing audio is for narration. The current tour point's audio will be played if the tour point is specified as being “higher priority”. Otherwise, its audio will not be played.

Step 708 is reached if audio is currently playing in the current tour point is not location specific, that is it has either a location specificity of float, or of nudge. The test at step 708 determines if the appropriate tour point FIFO is already full. If the FIFO has capacity to queue an additional tour point, then this routine's result is “Queue”.

Otherwise, step 709 determines if the current tour point has higher priority than the last tour point in the FIFO. A higher priority tour point will be queued, whilst a tour point that is not specified as being higher priority will not be queued or played.

D. Music Stopped Routine

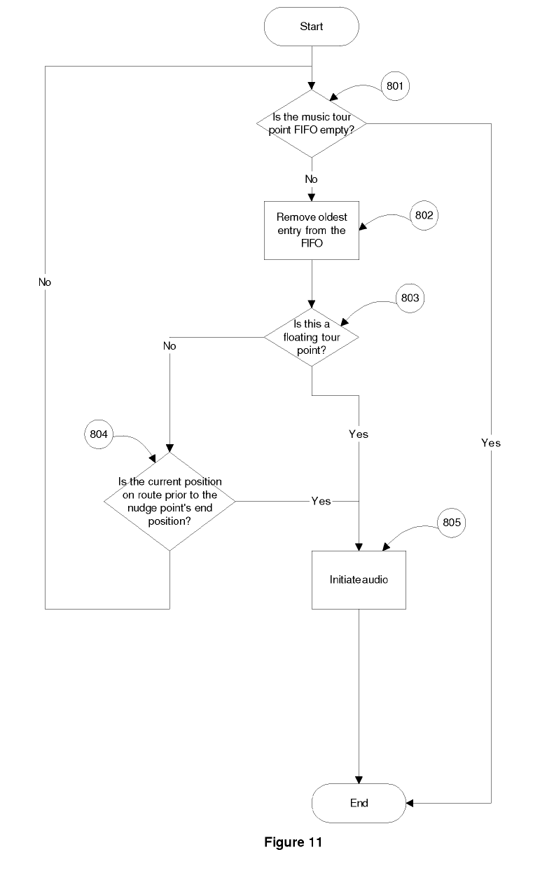

This routine is called by the music audio processor when a music file completes playing. This is illustrated in FIG. 11. This routine's job is to initiate playing audio of the next tour point in the music tour point FIFO. This is only done if the current position along the route is within that specified by the tour point's location specificity.

Step 801 first checks to see if the music tour point FIFO is empty. If the FIFO is empty, this routine has no further work to perform.

Step 802 removes the oldest tour point from the FIFO, making it available for further examination in later steps of this routine.

Only tour points with location specificity of either float or nudge will have been queued onto this FIFO in the first place. Step 803 examines the tour point's location specificity to see which it is.

Step 804 is reached if the tour point has a location specificity of nudge. Tour points with this location specificity have an associated predetermined endpoint specified. This endpoint defines the furthest position along the tour route at which point the tour point's audio is allowed to start playing. This step compares the current deemed position along the route with this endpoint. If the current deemed position is passed the endpoint, the tour point's audio is not played.

Step 805 is reached when the previous tests have shown that the tour point's audio should be played. This calls Initiate Audio to initiate playing of the audio associated with the tour point.

E. Talking Stopped Routine

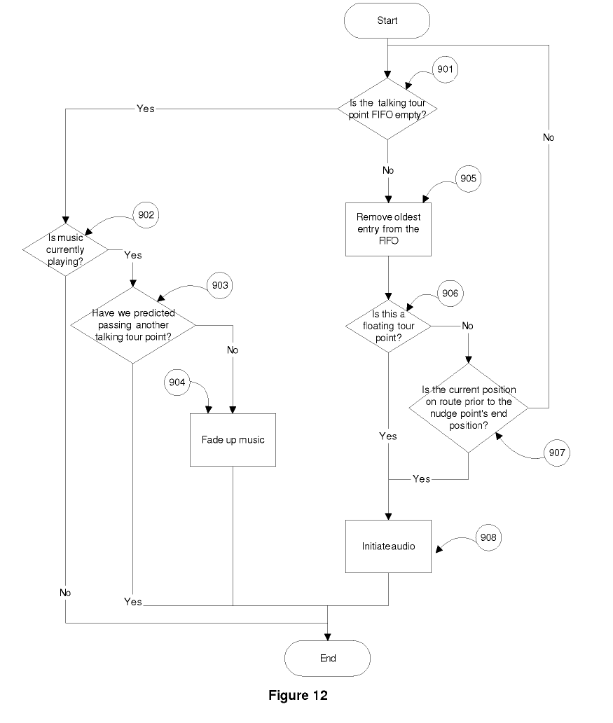

This routine is called when talking completes playing, and is illustrated in FIG. 12. Its job is to:
1. Initiate playing audio of the next tour point in the talking tour point FIFO. Again, this is only done if the current position along the route is within that specified by the tour point's location specificity.
2. Now that talking has stopped, initiate fade up of the music if appropriate.

Step 901 first checks to see if the talking tour point FIFO is empty. If the FIFO is empty, there is no further talking to play.

If there is no further talking to play, the music may need to be faded up. Step 902 first checks to see if music is currently playing. If not, this routine ends.

In step 903 the routine tests to see if the system predicts passing another talk type tour point imminently. This prediction is made within the Predictive Fading routine of FIG. 14, and stored in a module variable that is accessed here. If the system predicts that it is about to pass another talk type tour point, there is no point fading up the music and then immediately fading it back down again.

In step 904 the routine instructs the music audio processor to fade up that channel over a period such as 3 seconds.

Step 905 removes the oldest tour point from the FIFO, making it available for further examination in later steps of this routine.

Only tour points with location specificity of either float or nudge will have been queued onto this FIFO in the first place. Step 906 examines the tour point's location specificity to see which it is.

Step 907 is reached if the tour point has a location specificity of nudge. As explained above, tour points with this location specificity have an associated predetermined endpoint specified. This endpoint defines the furthest position along the tour route at which point the tour point's is allowed to start playing. This step compares the current deemed position along the route with this endpoint. If the current deemed position is passed the endpoint, the tour point's audio is not played.

Step 908 is reached when the previous tests have shown that the tour point's audio should be played. This calls Initiate Audio to initiate playing of the audio associated with the tour point.

F. Initiate Audio Routine

This routine is called to initiate playing the audio associated with a specific tour point. It is illustrated in FIG. 13.

Different actions need to be taken depending on whether the specified tour point is of type music or of type talking. This is checked in step 1001.

Step 1002 is the first in a sequence of steps handling a talk type tour point. Audio of a talk type tour point preferably plays at a nominated volume referred to as the talking volume level.

When talk is playing, it is intended that the music plays at a soft level. Typically prior to nearing the talk type tour point a prediction of this will be made, and an appropriate fade down of the music initiated. However, an accurate prediction cannot always be made, for example due to an accelerating vehicle. Step 1003 examines the music audio processor to determine whether or not the previously initiated fade down of music has completed.

If the fade down of music has not completed, step 1004 instructs the music audio processor to hasten the fade operation, so that there will be minimal overlap of high volume music whilst talking commences.

Steps 1005 and 1006 determine what volume level at which the music should play. If talking is currently playing, or if the system has predicted that talking is expected to shortly commence, the volume level is set to soft level referred to as the faded music volume level 1007. This prediction is made by the Predictive Fading routine in FIG. 14.

Otherwise, there is no talking currently playing and the system has not predicted passing a talk type tour point, so the music can play at a louder level referred to as the normal music volume level 1008.

Each tour point can have associated with it multiple audio files to play when the tour point is passed. Associated with each audio file, is an expression which must evaluate to true for the associated audio file to be played. If multiple expressions hold true, then the first expression that evaluates to be true takes precedence, and its associated audio files selected 1009. This is where Fine-Grained Narration Personalisation may be utilised (see below). This step calls the Conditional Expression Evaluation routine for each expression associated with the tour point.

Step 1010 determines which is the relevant audio processor instance for this tour point. For music type tour points, the music audio processor instance is relevant. For narration, navigation and stop type tour points, the talk audio processor instance is relevant.

Step 1011 instructs the relevant audio processor to commence playing the audio file determined in step 1009 at the volume level determined.

Step 1012 adds this tour point to the list of tour points that have been passed on the tour. This is part of the “tour state” maintained by the system.

In traditional audiovisual media people are accustomed to having background music whilst talking or other action takes the forefront. The music or score serves to create an emotional bed for the visuals, often the viewer is not even conscious of its existence. In these media, mixing of music, dialogue, narration and any other sound is the job of the editor.

The subtle fading between music and talking is absolutely critical to create a seamless media experience.

In a basic GPS narration system, premixing of music and talking cannot be done. Talking, consisting of narration and navigation style messages, may last a few seconds or a few tens of seconds for example, and commences playing at particular points along the route.

A music track can go on for many minutes, during which time multiple pieces of talk could start and stop. Whilst talking is playing, music is played at a soft volume, and whilst talking has stopped, music is played at a louder volume.

So that the transition between the soft playing of music and the loud playing of music sounds smooth, the music volume is faded between soft and loud over a period of a few seconds.

This is the “dynamic” component of music mixing, and has already been discussed in some detail above. The “predictive” component refers to when the music starts to fade. As mentioned, whilst talk is playing, the music is playing at a soft volume. When the talk completes, the music starts to fade up as soon as this occurs, and completes after a constant period of time, for example, over 3 seconds.

Knowing when to start fading down music is more complicated. The ideal is that the fade down occurs over a specific time period (again, for example, 3 seconds), timed such that it completes just as the talking commences.

This requires being able to predict when the traveller is 3 seconds from a particular point on the route. This is done by:
Determining the current speed from the GPS receiver
Determining the current position on the route
Determining the distance to the next tour point on the route

Once it has been calculated that the traveller is 3 seconds from the next tour point, the music begins to fade. The present algorithm initiates a fade regardless of any subsequent change in speed of the traveller.

If the traveller decelerates, then the music will complete fading down to the soft volume prior to the talk playing. Audibly this sounds reasonable.

If the traveller accelerates, then the music will still be quite loud as the talk starts playing. As the traveller passes the tour point and the talk starts playing, a fast “fade down” occurs (for example over 0.7 seconds). This ensures that there is a minimum of time whilst the talking commences that the music is still louder than desired.

G. Predictive Fading Routine

This routine is called whenever a location fix is supplied by the GPS receiver, and the Process GPS routine has determined the corresponding position on the route. This routine's job is to predict where the traveller will be along the route after x seconds.

It then determines if any tour points lie along the stretch of the tour route to that position, and if so, determines what fading should occur. This is illustrated in FIG. 14.

Step 1101 compares the deemed position determined by the Process GPS routine in FIG. 8 from the current GPS coordinates, with the deemed position calculated from the previous GPS coordinates. A comparison of these deemed positions reveals if the traveller is moving forward along the route or not.

Step 1102 calculates the current speed, using speed=(distance/time). Where the distance is the total distance travelled as derived from the last n GPS readings, and time is the time interval from the first and the last of these n readings. n is chosen such that the time interval is no greater than a certain threshold, such as 2 seconds.

Step 1103 calculates the prediction distance, i.e. the distance that is expected to be covered at the current calculated speed over the prediction time, which can be 3 seconds, for example. This is calculated by distance=speed*time.

Step 1104 takes the current deemed position and follows the route for the distance calculated in the previous step. This results in a predicted position, defined by a particular line segment within the route data structure, and the distance along that line segment.

Step 1105 is the commencement of a loop that considers the interval starting from the prediction position calculated in the last call to this routine, and the current prediction position.

Step 1106 searches the list of tour points of the tour, and finds the first playable tour point within the route interval from step 1105. Playable is defined as having at least one condition of play for any of the audio files associated with the tour point being satisfied.

The fading actions that occur are different depending on the tour point type which the system predicts it will pass, and the tour point type is checked in step 1107.

Step 1108 is the first in a series of steps for talk type tour points. This checks to see if talking is already playing on the talk audio processor.

By step 1109 the system has determined that there is no talk currently playing. The system checks with the music audio processor to see if music is currently playing.

At step 1110 the system has determined that music is currently not playing, so there is no music to fade down. In this case the system remembers in a module variable that it has predicted passing a talk type tour point. This is used in the Initiate Audio routine, allowing it to correctly determine what volume level to start playing any music.

Step 1111 instructs the music audio processor to fade down the music over an appropriate interval, such as 3 seconds. The music is faded from the current volume level, down to the faded music volume level.

At step 1112, the system predicts that the traveller is soon to pass a talk type tour point and that talk is currently playing. The next course of action depends on whether the predicted tour point is location specific and higher priority than the current one. If so, the predicted tour point must be played immediately when it is passed and the current one terminated. To provide a smooth effect, step 1113 instructs the talk audio processor to fade down the current talk from its current volume level down to zero, and then to stop playing that file.

Step 1120 is the first in a series of steps involving music type tour points. This checks to see if music is already playing on the music audio processor.

At step 1121, the system predicts that the traveller is soon to pass a music type tour point and that music is currently playing. The next course of action depends on whether the predicted tour point is location specific and higher priority than the current one. If so, the predicted tour point must be played immediately when it is passed and the current one terminated. To provide a smooth effect, step 1122 instructs the music audio processor to fade down the current music from its current volume level down to zero, and then to stop playing that file.

Step 1130 searches forward along the tour route starting at the position of the current tour point, towards the end of the interval considered in step 1105. If another tour point is found, it is processed in a similar way from step 1107.

Any period where talking is playing and music is louder than desired does not necessarily sound good to the user. Accordingly, it is preferable that:
Between the time the music fade commences and the tour point is physically reached, the traveller's speed is continuously analysed. If the traveller is accelerating, the speed at which the fade down occurs is accelerated. This will not guarantee that the fade will complete by the time the tour point is reached and the talking begin to play, but should minimise this interval.
Playing the talking is delayed until the fade completes. It is preferable for audio to be played as closely as possible to the intended position along the route. GPS receivers are accurate to approximately 15 m, so in general additional delays are not desirable.

Some preferred embodiments of the invention also include a number of additional features.

### H. Conditional Expression Evaluation

The background to this is the concept of Fine-Grained Narration Personalisation, which can personalise and contextualise the audio information, to provide a natural, narrative effect to the user.

Preferably, the narration is recorded using various real characters including someone having the role of “tour guide”. A number of concepts described here ensures that tourists will not feel that their computer-based tour guide is a recording that simply announces at specific locations.

In general terms, the narration is personalised based on the tour state at the time of the narration. A human tour guide would tailor the commentary in such a way, and Fine-Grained Narration Personalisation seeks to provide similar such tailoring. The tour state may depend, for example, on whether or not part of the tour was taken. Previous narration may have guided a tourist to a particular tour point that is expected by the content developer to be of interest. However, whether or not a tourist actually went passed a tour point will be an individual matter, and as such is part of the tour state.

The Tour State data structure consists of items relating to the current tour state. This is held in non-volatile storage so that it will still be available should the system be restarted.

The tour state includes a list of tour points that have been passed. This list is emptied when the tour is started, and is updated by the Initiate Audio routine.

The tour state also has a list of stop type tour points at which the invention deems the traveller to have stopped at. This is updated by the Process GPS routine.

Narration can be tailored based on the Tour State data. For example, if the tourist had passed a previous tour point, the narration could be “The mediaeval steeples of the approaching church are very different to those of the Gothic church we saw earlier today”. If the tourist had not passed the previous tour point, the narration could be different, for example “you will notice the mediaeval steeples of the approaching church. Shame you missed the Gothic church earlier today—there is such a contrast!”

There are multiple advantages for narration tailoring. Firstly, tailoring provides the possibility of richer content. In an informational sense, being able to refer back to previous experiences allows the narration to compare points of interest. Interesting facets can therefore be highlighted in a way not possible if narration about a point of interest must be stand-alone only. Tailoring also creates a subtle feeling of a personal tour for the tourist and of interactivity. The narration is therefore not simply about the point of interest, but is subtly about the tourist as well.

There are many conditions on which narration tailoring can occur. Some of these have been touched on above and those and others include:
Passed Tour Point Condition. This condition is true if the tourist had actually passed a specific tour point, and is illustrated in the above example.
Stop Point Dependent Conditions. A Stop Point is a tour point where the content developer expects that the tourist will spend some time to experience. This condition is different to the “Passed Tour Point” condition described above. For this to be true, it does not only require that the tourist passed a particular tour point, but also that he remained there for a certain minimum duration.
Time Dependent Conditions. For example, if a tour point is passed around dusk, the following narration would be appropriate “At this time of day, we really need to drive carefully . . . the kangaroos love crossing this stretch of road”. Or if travelling earlier on “At dusk this stretch of road is amazing . . . the kangaroos really love crossing here”
Date Dependent Conditions. Narration can be similarly tailored based on date ranges. This could be useful for example in describing features differently depending on season in which the tour is taken.
Attraction Opening Times Dependent Conditions. The tour scheduler described later, contains information regarding facility opening times. An “attraction” in this context could be a shop, museum, market or a local event for example. Conditions based on attraction opening times could be date and/or time relative. Narration tailoring would permit “the markets are open today, so if local jams, preserves and remedies take your fancy pull up just ahead”, or “this quiet stretch of road turns into a bustling market every Sunday complete with . . .”.
The use of Attraction Opening Times as a condition requires a detailed database of attraction opening times. Each attraction is identified by name, and includes a list of opening times. The opening times can be specified differently based on day of week or day of month, and can include exception cases as well.
Preferably, the tour data structure does not include this information directly, but rather includes the filename of the file that possesses this information.
Speed/Acceleration Dependent Conditions. An enhanced sense of personalisation can be achieved by occasional narration perhaps referring to traffic jams, or going over the speed limit.
Tour Scheduler Dependent Conditions. The tour scheduler contains information regarding future tour activities. Tourists may or may not have used the scheduler, and so specific tour activities may be unscheduled, scheduled to occur or scheduled not to occur. Conditions based on activity schedule can allow for narration such as “I know you haven't decided yet about going to see the blowhole later on today, but if you want to get an idea of where the locals go to on a sunny afternoon, that is your best bet”. Or, “if you like the view from up here, you are in for a real treat when we get to Cathedral Mountain later on”.
Tour Scheduler preferably adapts the itinerary dynamically. For example, based on having a full day of touring scheduled and wanting to have the tour completed by a reasonable time. It is also based on such things as lunch requirements or opening times of attractions.
For example, if a traveller is running late, there is no point sending him/her on a 20 kilometre drive to an attraction if it would be closed by the time the traveller reaches there. The system makes reasonable recommendations to the traveller so that they know what is happening, and can make an informed decision.

### Expressions

An expression is built on top of one or more of the conditions defined above, and can be thought of as complex conditions. For example, an expression can be:
A Boolean condition
The logical inverse of Expression1
The logical conjunction of Expression1 with Expression2
The logical disjunction of Expression1 with Expression2
A named expression

### Named Expressions

Some expressions may need to be used in a number of places. Named expressions are defined in as part of the Tour Data Structure, and can be used multiple times for Fine-Grained Narration Personalisation.

One or more of the conditions and/or expressions can be used in varying embodiments of the invention.

### Flow Chart Description

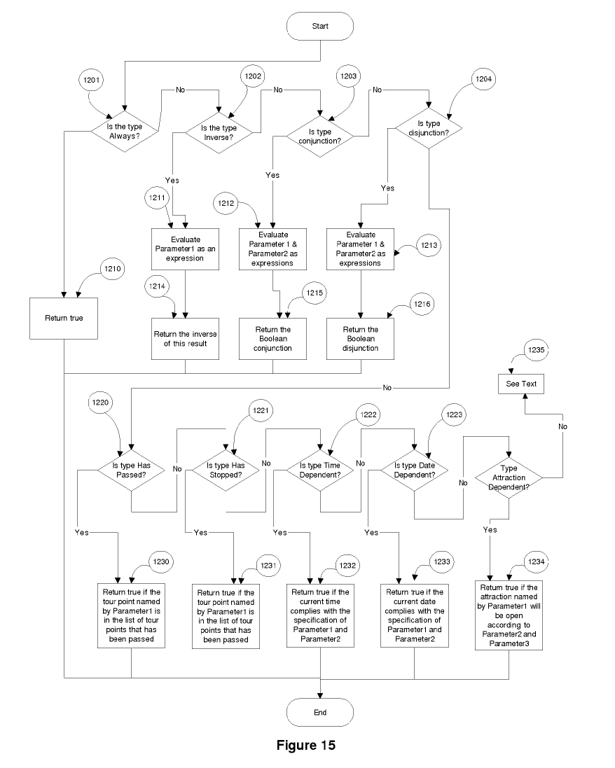

This routine is called to evaluate a Tour Point Conditional Expression, and is used to determine which if any audio file should be played when a tour point is passed for instance. It is illustrated in FIG. 15. Note that some elements of this routine are not shown in the figure, and are only described textually below,

A Tour Point Conditional Expression has a type element which is evaluated by steps 1201, 1202, 1203, 1204, 1220, 1221, 1222 and 1223 to determine how the expression element will be evaluated.

If the expression type is Always, then 1210 is processed, and the routine returns true.

If the expression type is Inverse, then 1211 calls this routine recursively to evaluate Parameter1 as the expression, and 1214 inverses this result.

If the expression type is Conjunction, then 1212 calls this routine recursively to evaluate Parameter1 and Parameter2 as expressions, and 1215 calculates the conjunction of these results.

If the expression type is Disjunction, then 1213 calls this routine recursively to evaluate Parameter1 and Parameter2 as expressions, and 1216 calculates the disjunction of these results.

If the expression type is Has Passed, then 1230 looks up the tour point has passed list, and returns true if the tour point named by Parameter1 is on the list.

If the expression type is Has Stopped, then 1231 looks up the tour point has stopped list, and returns true if the tour point named by Parameter1 is on the list.

If the expression type is Time Dependent, then 1232 checks Parameter1. If Parameter1 is Before, and if the current time of day is before the time specified by Parameter2, this routine returns true. If Parameter1 is After, and if the current time of day is after the time specified by Parameter2, this routine returns true.

If the expression type is Date Dependent, then 1233 checks Parameter1. If Parameter1 is Before, and if the current date is before the date specified by Parameter2, this routine returns true. If Parameter1 is Equal, and if the current date is equal to the date specified by Parameter2, this routine returns true. If Parameter1 is After, and if the current date is after the date specified by Parameter2, this routine returns true. In performing these date comparisons, only the day and month components of the date are considered, and the year is ignored.

If the expression type is Attraction Dependent, then 1234 accesses the Attraction Opening Database for the Attraction Opening Entry specified by Parameter1. If there is no such attraction in the database, then this routine returns false if Parameter2 is Opening, and true if Parameter3 is Closing. If there is the named attraction in the database, then this routine evaluates all associated Attraction Opening Slots and exclusion slots against the current time and date and the timeframe specified by Parameter3.

If the expression type is Speed Dependent, then the instantaneous speed is determined by calculating the distance and time between the last 2 GPS readings. This routine returns true if the speed is greater than Parameter2 and Parameter1 is Above, or the speed is less than Parameter2 and Parameter1 is Below.

If the expression type is Acceleration Dependent, then the current speed is determined by calculating the distance and time between the last 2 GPS readings. The previous speed is determined by calculating the distance and time between the 2 consecutive GPS readings that were taken closest to n seconds previously, where n is equal to Parameter3. The acceleration is calculated using the current speed, the previous speed and the time interval between those readings. This routine returns true if the acceleration is greater than Parameter2 and Parameter1 is Above, or the acceleration is less than Parameter2 and Parameter1 is Below.

### I. Determine Deemed Position

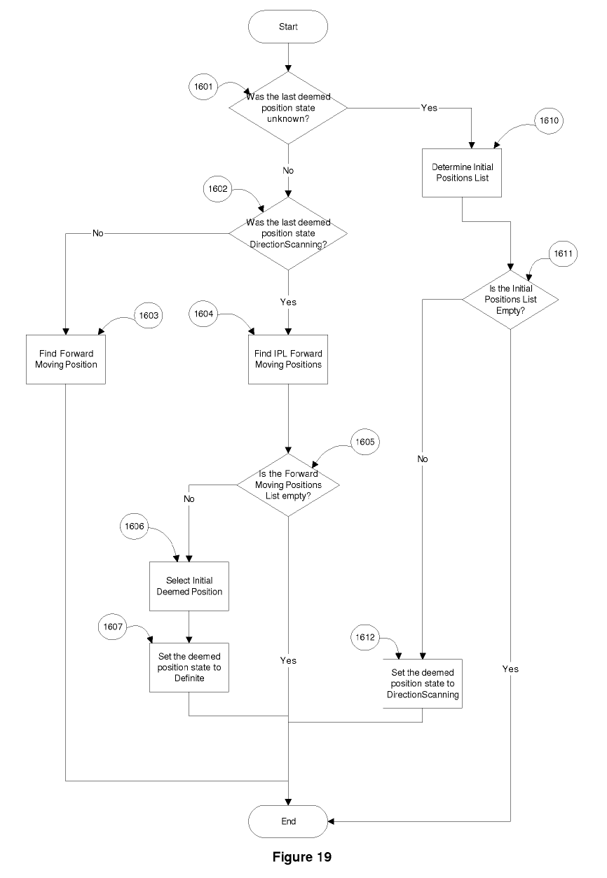

This routine is used to determine the current “deemed position”. This could result in a determination that the coordinates are definitely on the route at an identifiable single position, definitely off the route, or on the route at an unidentifiable position. This is illustrated in FIG. 19.

The processing of this routine depends on the last determined deemed position state, and this is tested in steps 1601 and 1602. On system initialisation the deemed position state would be set to “unknown”.

If the last determined deemed position state is “unknown”, then 1610 calls the routine to determine the Initial Positions List. The reference position, i.e. the current GPS coordinates, may be too far away from the route to be considered “on route”, in which case the Initial Positions List will be empty. This is checked in step 1611.

If there is 1 or more Positions in the Initial Positions List, the deemed position state is changed to DirectionScanning so that future GPS coordinates will be suitably processed. This is done in 1612.

Step 1604 is processed if this routine is called when the deemed position state is DirectionScanning and calls the Find IPL Forward Moving Positions routine. Step 1605 checks to see whether or not the current coordinates were considered forward moving along the route relative to the Initial Positions List. Step 1606 calls the routine to select one of the positions from the Forward Moving Positions List as the deemed position, and step 1607 changes the deemed position state to Definite.

The multistage process of determining the Initial Positions List, the subsequent determination of the Forward Moving Positions list and the selection of one of these positions as the deemed position leads to multipass support, whereby the tour route can double back on itself in certain parts over the same geography, and the invention will correctly work out where on the route are the current coordinates, given where the tour has previously been.

Step 1603 is performed when the last deemed position state is either “definite”, “minor reverse” or “possible”. Its job is to determine the current deemed position along the route, as well as the deemed position state.

The determination may be that the coordinates are too far away from the closest point on the route, in which case the deemed position is “unknown”. At the point where path options diverge, for example, near the intersection of PO1, PO2 and PO3 in FIG. 4, a single determination cannot be made. Given the GPS signal accuracy, coordinates near this intersection could perhaps lie on either PO2 or PO3. In such a case the deemed position is termed possible. This means that the coordinates do lie on the route, but a single definite position cannot be determined.

The deemed position will only be classified as “definite” if the position is forward along the route compared with the last determination. If the position is backward compared with the last determination, the distance between the current determination and the previous is calculated. If this distance is below a certain threshold, for example 30 m, the deemed position is classified as “minor reverse”. This allows for the traveller to perform a short reverse without the system indicating that the traveller is off route. This also allows for fluctuations in coordinates reported by the GPS receiver if the traveller is stationary to not cause an “off route” indication.

If the calculation between the current position on the route, and the previous one is such that it is greater than the threshold value for a minor reverse, the deemed position is classified as “unknown”, and the system gives an “off route” indication.

### J. Determine Initial Positions List

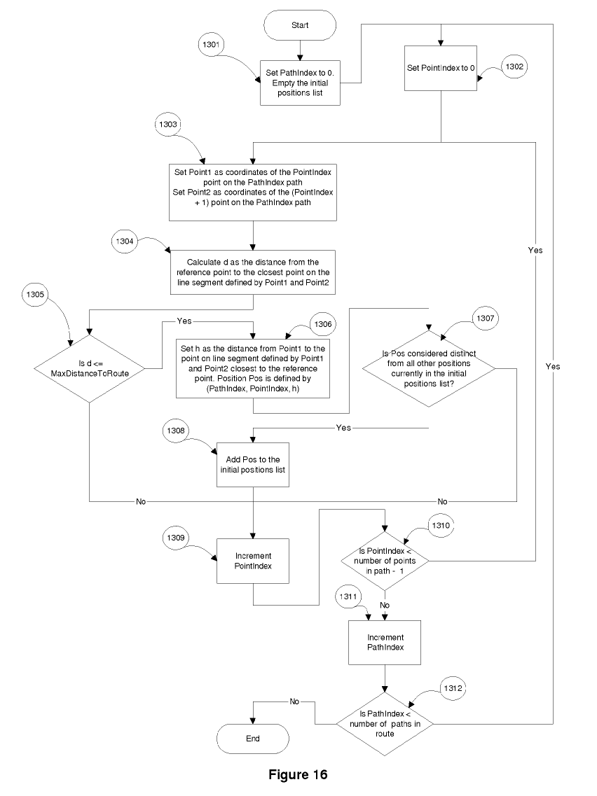

The routine illustrated by flowchart shown in FIG. 16, is used as part of the process to determine where on the route is the reference point, the reference point being the current GPS coordinates. The output of this routine is the Initial Positions List, which is a list of zero or more positions on the route that are sufficiently close to the reference point. This routine operates by looping through all paths in the route. Step 1301 initialises the loop to start from the first path. It also clears the initial positions list.

Step 1302 is the start of the loop for each path. There is a sub loop commencing at step 1303 that operates on every point in the path. 1302 initialises the loop to start at the first point.

1303 obtains the coordinates for the current point in the loop as well as the next point.

1304 calculates the distance between the reference point and the line segment defined by these two points.

1305 determines whether or not this distance is close enough to the route so that it can be classified as being on the route. In one embodiment, the maximum permitted distance is 35 m. In another embodiment, the maximum permitted distance would be a function of the path width.

Step 1306 is the start of a few steps that are executed if the reference point is classified as being on route. 1306 calculates the position along the line segment that is closest to the reference point.

Step 1307 is used to ensure that only significantly distinct positions are added to the initial positions list at 1308. It does this by looping through all positions already in the initial positions list, and calculating the distance between Pos and each position. If the distance any existing position is greater than a certain threshold, preferably 100 m, the position is considered distinct and added to the list at 1308.

Steps 1309 and 1310 continues the loop that iterates through all points on the current path.

Steps 1311 and 1312 continues the loop that iterates through all paths on the route.

### K. Find IPL Forward Moving Positions

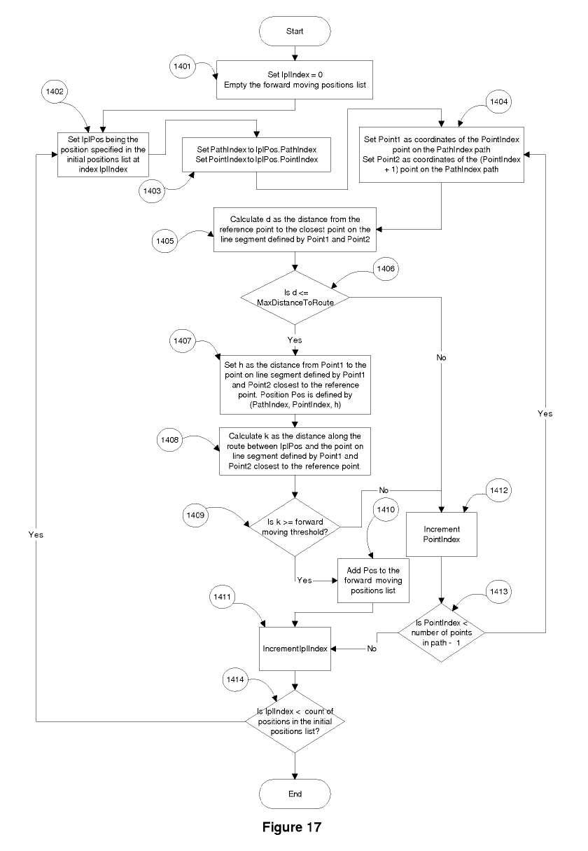

The routine illustrated by flowchart shown in FIG. 17, is used as part of the process to determine where on the route is the reference point, the reference point being the current GPS coordinates. The output of this routine is the Forward Moving Positions List, which is a list of zero or more positions on the route that are sufficiently close to the reference point.

The maximum number of positions that will be output onto this list will be equal to the number of positions in the Initial Positions List when this routine is called.

This routine operates by looping through each position in the Initial Positions List, and step 1401 initialises IpIIndex to start from the first entry in the list.

Step 1402, 1403 and 1404 setup variables used in later processing.

Step 1406 determines whether or not reference point is close enough to the current line segment such that it can be considered on route.

Step 1408 calculates the distance along the route as described, and does this by looping through the points between IpIPos and Point1, adding in the distance calculated in step 1407.

Step 1409 determines whether or not this distance reaches the threshold such that we can now consider the reference position to have moved sufficiently forward of the associated position in the Initial Positions List.

Step 1410 adds the position to the Forward Moving Positions list.

Steps 1412 and 1413 complete the loop that attempts to find a forward moving position for.

Steps 1411 and 1414 completes the loop to process all positions from the Initial Positions List.

### I. Select Initial Deemed Position

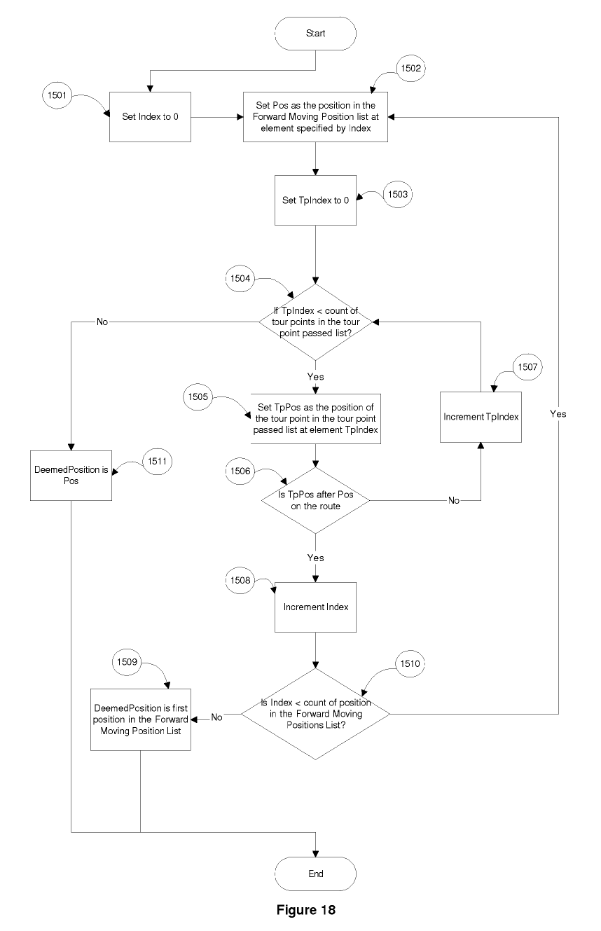

The routine illustrated by flowchart shown in FIG. 18, is used to select which of the possibly multiple positions within the Forward Moving Positions list should be selected as the Initial Deemed Position.

This routine operates as two loops, the outer loop processing each position within the Forward Moving Positions list. The inner loop is used to determine whether or not the position has been passed whilst previously on the tour.

### J. Start Return to Tour Music

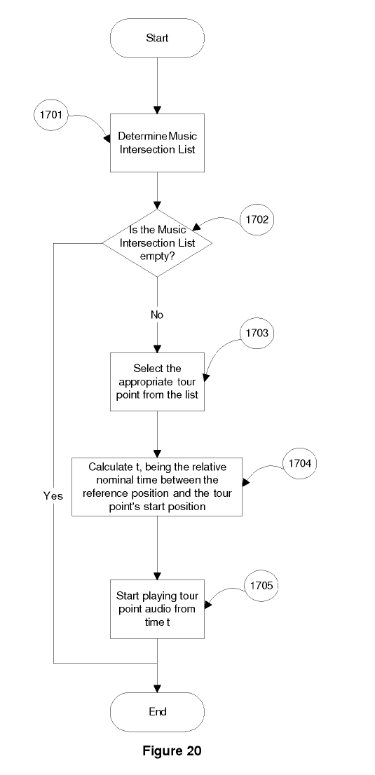

This routine is called when a traveller's position becomes definite, and is used to start playing appropriate music. This is shown in FIG. 20.

Step 1701 determines the list of music tour points located before the reference position, and has an audio length such that at the nominal travel times included in the Tour Route Data Structure, the audio would complete playing prior to the reference position.

Step 1702 checks to see if there is at least one tour point that matches this criteria. If there are none, no music is started.

Step 1703 one of the possibly multiple tour points in the music intersection list. Preferably, this selection will be based on the tour point closest to the reference point.

1704 calculates the time that it would take under nominal travel times included in the Tour Route Data Structure, between the tour point position and the reference position.

Step 1705 instructs the music audio processor to start playing the tour point's audio starting at the time calculated in the previous step. This step also instructs the music audio processor to fade the music up.

### Travel Navigation Software Integration

In one embodiment of this invention, there is limited user interface, primarily to cater for tour selection. In another embodiment, the system of this invention is integrated with commercially available travel navigation software. In this case, the user interface is a combination of the elements described in this specification, together with the user interface provided by the travel navigation software. This would include a map of the area together with the current traveller's location and direction highlighted.

In one anticipated use of the system, the traveller would stay on the pre-defined tour route for certain periods of time, whilst being guided and entertained by the invention.

However, there will be times when the traveller wants to explore something by himself and leave the tour route. On many of these occasions the user will require guidance to the desired destination, which is not on the tour route.

For such circumstances, in some embodiments this invention integrates commercially available travel navigation software to provide guidance to the traveller when not on the pre-defined tour route. This is of use in several scenarios including:
1. When the user is on tour or off tour and wants to travel to a particular off tour destination
2. When the user is off tour and wants to return to the tour

Although the traveller is free to select and activate the Travel Navigation Software at any point in time from the invention's user interface, the system automatically does this when it detects that the traveller has come off route.

When the traveller wants to return to tour, a certain selection is made from the user interface. This includes the following options:
1. Return to where the tour was last left
2. Go to the closest point on the tour from the current location
3. Go to a specific point on the tour. The traveller is presented with a list of significant points on the tour, from which a selection can be made.

Once the selection has been made, the Travel Navigation Software is instigated to give directions to the traveller. Once it has been determined that the traveller is on the tour route, the Travel Navigation Software is disengaged. At this point return-to-tour music recommences (if appropriate) and the standard in-tour operation of the invention continues.

As previously touched on, music recommencement occurs by performing various calculations when the system determines that the traveller has returned to the tour. This involves determining what is the nearest music type tour point prior to the return-to-tour position.

Based on the nominal speeds associated with the tour route, the system calculates the nominal position (timewise) within the music track. It then commences playing the music from this nominal position. The music is played or mixed with talk depending on the presence of a talk type tour point at the position where the traveller returns to tour.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A tour guidance system adapted to selectively deliver pre-recorded media data to a user, the tour guidance system comprising:
position identification means for determining positional data concerning the user;
data storage means adapted to store tour route data, tour point data, and media data associated with at least one tour route and/or at least one tour point;
processing means adapted to process the tour route data and/or the tour point data and selectively determine the delivery of at least a first segment of media data relevant to the user's position, the determination based on prioritisation of delivery of one or more of a plurality of segments of media data with reference to at least a predetermined tour point priority parameter; and
media delivery means adapted to deliver one or more of the plurality of segments of media data selected by the processing means.

2. The tour guidance system according to claim 1, wherein the tour point data includes at least one tour point type.

3. The tour guidance system according to claim 2, wherein the tour point type is selected from a navigation type tour point, a narration type tour point, a stop type tour point, and a music type tour point.

4. The tour guidance system according to claim 3, wherein more than one of a navigation type tour point, a narration type tour point, a music type tour point and a stop type tour point are encountered by the system substantially simultaneously or within substantially the same vicinity.

5. A logic unit adapted for integration with a tour guidance system, the logic unit adapted to dynamically mix at least two segments of media data being delivered to a user of the tour guidance system, said logic unit comprising:
altering means adapted, to selectively alter a first property of a first segment of media data and/or a second property of at least a second segment of media data,
said alteration made with reference to the tour point type of the one or more tour points.

6. A logic unit adapted for integration with the tour guidance system of claim 5, the logic unit adapted to dynamically mix at least two segments of media data being delivered to a user of the tour guidance system, said logic unit comprising:
predicted position determining means adapted to predict the likely position, relative to the tour route, at which the user will arrive in a predetermined time interval;
tour point determining means adapted to determine whether there is one or more tour points between a previously determined predicted position and the predicted likely position; and
altering means adapted, depending on the presence of at least one tour point between the previously determined predicted position and the predicted likely position, to selectively alter a first property of a first segment of media data and/or a second property of at least a second segment of media data,
said alteration made with reference to the tour point type of the one or more tour points between the previously determined predicted position and the predicted likely position and the type of media data being delivered when the predicted likely position is determined.

7. A method of providing tour guidance to a user based on current position data, comprising:
storing tour point data for a plurality of tour points to be visited by a user in a tour, the tour point data including:
information on the location of at least one tour point;
a segment of media data relevant to at least one tour point; and
a priority parameter associated with at least one tour point;
determining position data relevant to the position of the user during a tour
in accordance with the position data determining if the user is adjacent to a tour point, selectively delivering to the user a first segment of stored media data relevant to that tour point in accordance with the priority parameter.

8. A media mixing method for dynamically mixing at least two segments of media data being delivered according to the method of claim 7, said media mixing method comprising:
predicting the likely position, relative to the tour, at which the user will arrive in a predetermined time interval;
determining whether there is one or more tour points between a previously determined predicted position and the predicted likely position; and
depending on the presence of at least one tour point between the previously determined predicted position and the predicted likely position, selectively altering a first property of a first segment of media data and/or a second property of at least a second segment of media data,
said alteration made with reference to the tour point data of the one or more tour points between the previously determined predicted position and the predicted likely position and a type of media data being delivered when the predicted likely position is determined.

9. A tour guidance system according to claim 1, wherein
the data storage means further stores location specificity data of at least one tour point; and
the processing means is adapted to determine the delivery of at least a first segment of media data further based on the user's position and the location specificity data.

10. A tour guidance system according to claim 9, wherein the location specificity data is a length along the tour route or lengths along parts of the tour route that the media data associated with the at least one tour route/and or tour point should be delivered.

11. A tour guidance system according to claim 1, wherein
the data storage means further stores user tour history data including, media segments previously delivered, tour points previously passed by the user, and/or time spent by the user at one or more positions along the tour route; and
the processing means is adapted to determine the delivery of at least a first segment of media data based further based on the user's tour history data.

12. A tour guidance system according to claim 1, further comprising
means for receiving the current date, current time, the user's current speed, acceleration, and/or direction; wherein
the processing means is adapted to determine the delivery of at least a first segment of media data further based on the current date, current time, user's current speed, acceleration and/or direction.

13. A tour guidance system according to claim 1, wherein
the data storage means further stores a predetermined ordering of the tour points along a route; and
the processing means is further adapted to determine the delivery of at least a first segment of media data further based on the user's position within the predetermined ordering of tour points along a tour route.

14. A method of providing tour guidance according to claim 7, wherein
the step of storing tour point data further comprising storing a location specificity parameter of at least one tour point; and
the step of determining delivering to the user the first segment of stored media data further based on the location specificity parameter.

15. A method of providing tour guidance according to claim 14, wherein the location specificity parameter is a length along the tour route that the media data associated with the at least one tour route/and or tour point should be delivered.

16. A method of providing tour guidance according to claim 7, wherein
the step of storing tour point data further comprising storing user tour history data including, media segments previously delivered, tour points previously passed by the user, and/or time spent by the user at one or more positions along the tour route; and
the step of determining delivering to the user the first segment of stored media data further based on the user's tour history data.

17. A method of providing tour guidance according to claim 7, wherein
step of storing tour point data further comprising storing current date, current time, the user's current speed, acceleration, and/or direction; and
the step of determining delivering to the user the first segment of stored media data further based on current date, current time, the user's current speed, acceleration, and/or direction.

18. A method of providing tour guidance according to claim 7, wherein
step of storing tour point data further comprising storing a predetermined ordering of the tour points along a route; and
the step of determining delivering to the user the first segment of stored media data further based on the user's position within the predetermined ordering of tour points along a tour route.
